(19) United States
(12) Patent Application Publication
(10) Pub. No.: US 2012/0202164 A1
(43) Pub. Date: Aug. 9, 2012

(54) Orthodontic Maxillary Micro Implant

(75) Inventors: Hong-Kung HSU, Kaohsiung City (TW); Wen-ping YUO, Kaohsiung City (TW)

(73) Assignees: Geo-Protector Technology Co., Ltd.; Best Medical & Dental International Inc.;

(21) Appl. No.: 13/024,308

(22) Filed: Feb. 9, 2011

(51) Int. Cl. A61C 7/00

(52) U.S. Cl. 433/18

(57) ABSTRACT

An orthodontic maxillary micro implant includes a plate and a corrective accessory. The plate is implanted into the keratinized epidermal tissue in the maxilla of the orthodontic patient's oral cavity. First and second locking elements are passed through first and second locking holes situated at both ends of the plate respectively to secure the plate to the maxilla, and finally a third locking element is affixed through a fourth locking hole situated on the corrective accessory and a third locking hole situated on the plate to secure the corrective accessory to the maxilla. The orthodontic maxillary micro implant overcomes the difficulty of tongue operation and reduced oral hygiene maintenance caused by the large surface area that a conventional maxillary device occupies. With the use of orthodontic wires, the orthodontic maxillary micro implant becomes an orthodontic accessory allowing the patient's teeth to be moved backward, pulled forward, pushed sideways or retracted.

### BACKGROUND OF THE INVENTION

1. Field of the invention This invention relates to an orthodontic maxillary micro implant, more specifically an orthodontic maxillary micro implant inserted into the maxilla of the oral cavity for orthodontics.

2. Description of Related Art

Conventional orthodontic plates 1 are composed of a plate 11 made of resin, and two corrective parts 12, 13 fixed into and extending from the plate 11 (As shown in FIG. 1), these corrective parts 12, 13 are made up of orthodontic O-rings 121, 131 and wires 122, 132 respectively.

When using conventional orthodontic plates 1 for orthodontic correction on the posterior teeth, an adhesive is used to affix the resin plate 11 to the maxilla of the orthodontic patient's oral cavity (As shown in FIG. 2), and ends of these corrective parts 12,13 are orthodontic O-rings 122, 132 attached to both sides of posterior teeth on the maxilla of the orthodontic patients oral cavity, the other ends 122, 132 having wires which are attached to both sides of the posterior teeth needing correcting, thus applying force and thereby moving the teeth.

Although conventional orthodontic plates correct the orthodontic patients teeth, they have the following drawbacks: 1. Placement of the device is not easy: every tooth's growth and placement angle varies, and conventional orthodontic plates are not easy to adjust, resulting in inconvenience when affixing the orthodontic plate; 2. The resin plate area is too large: conventional orthodontic plates 1 require a large surface area and increased thickness in order to provide sufficient grip for keeping the resin plate 11 affixed. As a result, the tongue space is reduced and difficulties in talking, chewing and swallowing arise, as well as difficulty in maintaining oral hygiene; 3. Restrictions in functions: current placement of the orthodontic device is by the premolar being attached to the maxilla, so when the molars move backward, it inevitably results in the anterior teeth moving forward and the lips protruding outwards as a result.

Therefore, how to improve conventional devices and their resulting problems described above is a subject for the orthodontic industry to overcome.

### SUMMARY OF THE INVENTION

The purpose of this invention is to provide a kind of orthodontic maxillary micro implant, using a plate and a corrective accessory to carry out orthodontics and re-alignment of the maxillary teeth and maxilla in the oral cavity where the plate is installed inside the keratinized epidermal tissue of the orthodontic patient's maxilla. A first locking element and a second locking element affix the plate to the maxilla, and a third locking element passes into the top of the corrective accessory of the fourth fixed locking hole and the third fixed locking hole, which is between the first fixed locking hole and second fixed locking hole situated on the top of the plate, thereby achieving the purpose of firmly locking the corrective accessory to the plate.

Another objective of this invention to provide a kind of orthodontic maxillary micro implant, is utilizing the plate and the corrective accessory to realign the maxillary teeth of the orthodontic patients oral cavity, enabling it to work unimpeded regardless of a tooth's growth or placement angle, and this invention provides a good adhesion method as it affixes to the hard cortical bone of the maxilla, and not an adhesion method relying on the teeth to hold the plate in position.

Another objective of this invention to provide a kind of orthodontic maxillary micro implant where the surface area of the orthodontic maxillary implant is small, so that after implanting, it won't affect the function of the orthodontic patients tongue and won't result in the orthodontic patient having a speech impediment or difficulty in swallowing and chewing. It also won't result in difficulty to maintain oral hygiene.

Another objective of this invention is to provide a kind of orthodontic maxillary micro implant, and after the micro implant is implanted in the cortical bone of the maxilla, the process of realigning maxillary teeth in the oral cavity is carried out while enabling the orthodontic patients premolars or molars to move and realign as necessary, so that it won't result in the anterior teeth protruding forwards

In order to achieve the abovementioned objectives of this invention, the technical measures comprise: a plate, having a first locking hole and a second locking hole situated at opposite ends of the plate and penetrating through the plate, a third locking hole placed between the first locking hole and second locking hole; a corrective accessory, possessing a main body, and a fourth fixed locking hole situated in the center of this main body, and a first groove and second groove on the main body, for accommodating at least one orthodontic wire.

### BRIEF DESCRIPTION OF THE DRAWINGS

This invention, as well as its many advantages, may be further understood by the following detailed descriptions and drawings, in which:

FIG. 1 is a schematic view of a conventional orthodontic plate;

FIG. 2 is a schematic view of a conventional orthodontic plate installed in an oral cavity;

FIG. 3a is the top view of the plate of the orthodontic maxillary micro implant in accordance with the present invention;

FIG. 3b is a side view of the plate of the orthodontic maxillary micro implant in accordance with the present invention;

FIG. 4a is a side view of the orthodontic appliance of an orthodontic maxillary micro implant in accordance with the present invention;

FIG. 4b is an exploded view of the plate and the orthodontic appliance of the orthodontic maxillary micro implant in accordance with the present invention;

FIG. 4c is a schematic view of the orthodontic maxillary micro implant in accordance with another preferred embodiment of the present invention; and

FIG. 5 is a schematic view of a dental maxillary micro implant installed at the maxilla of an orthodontic patient's oral cavity in accordance with the present invention.

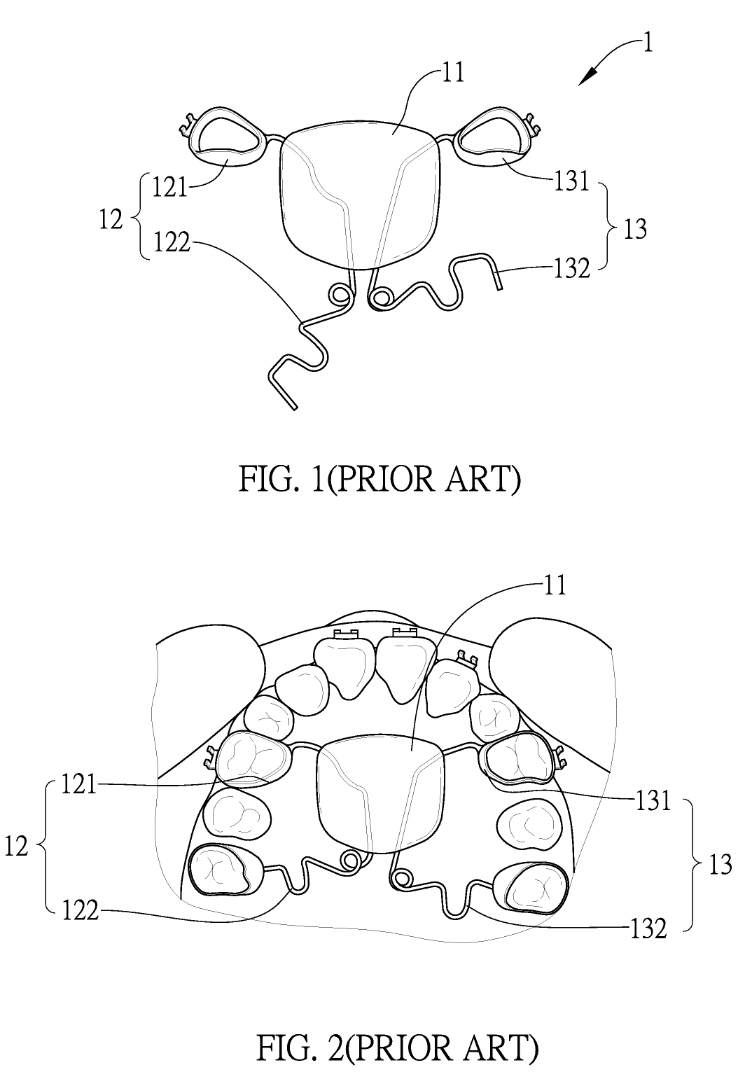

### DETAILED DESCRIPTION OF THE INVENTION

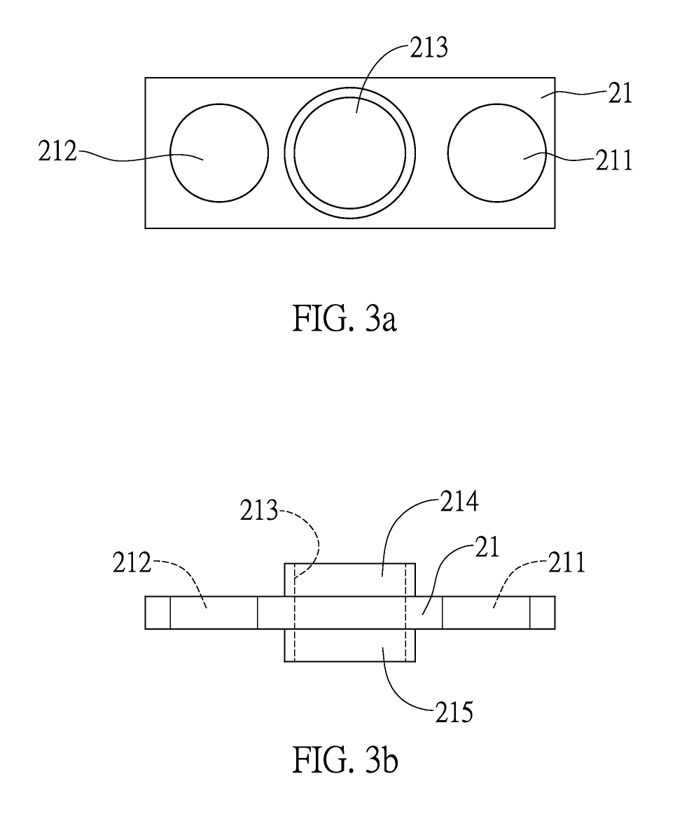

With reference to FIGS. 3a to 5 for an orthodontic maxillary micro implant of the present invention, the orthodontic maxillary micro implant comprises a plate 21 and a corrective accessory 22.

In FIGS. 3a and 3b, the plate 21 comprises: a first locking hole 211 and a second locking hole 212 situated at each end of the plate 21, and penetrating through the plate 21, and situated opposite to each other; a third locking hole 213 is situated between the first locking hole 211 and the second locking hole 212; and a first circular protrusion 214 and a second circular protrusion 215 extend from the top and bottom surfaces of plate 21 respectively.

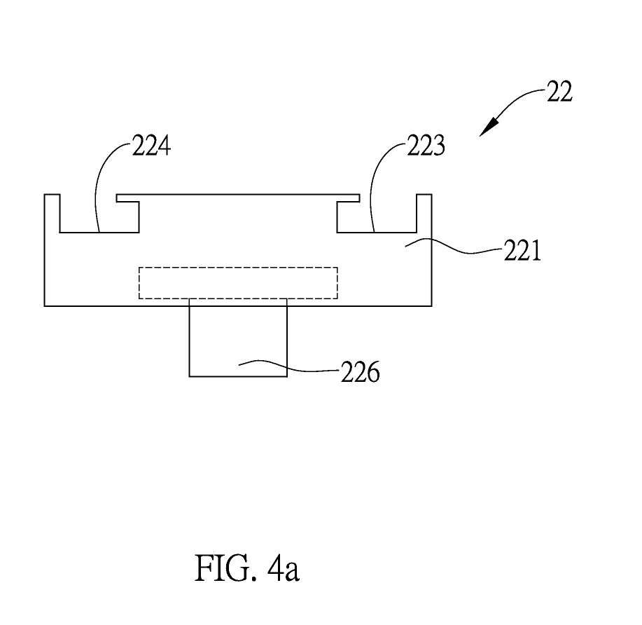

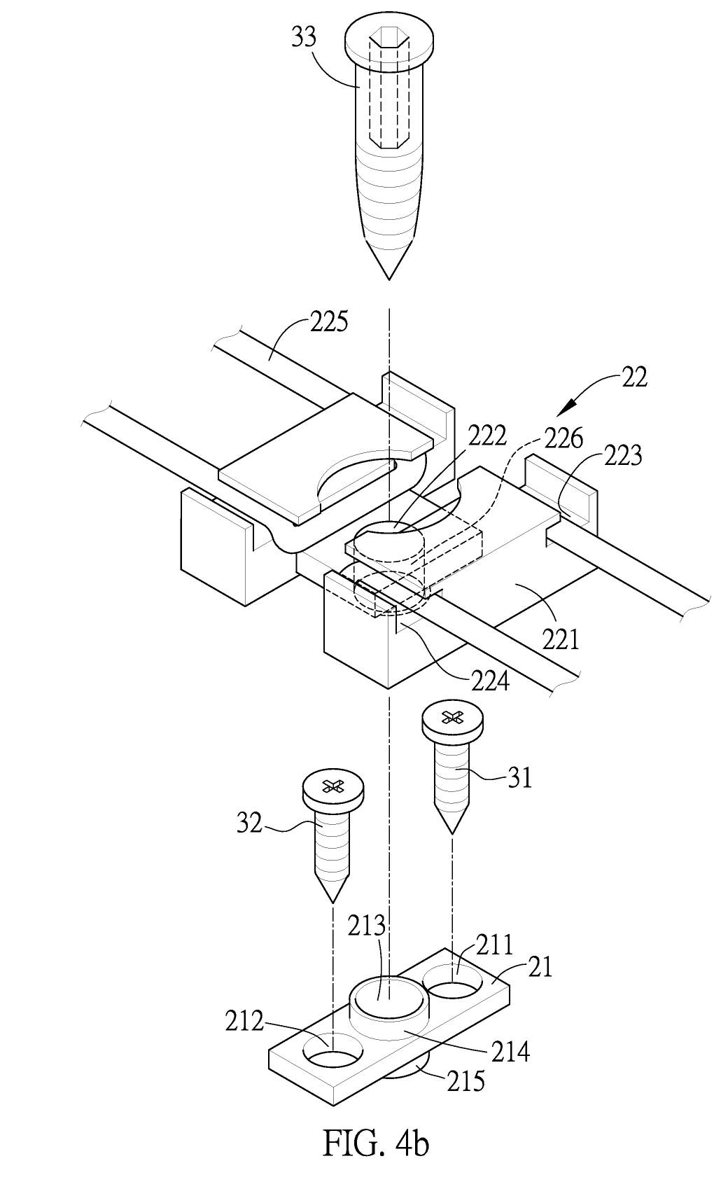

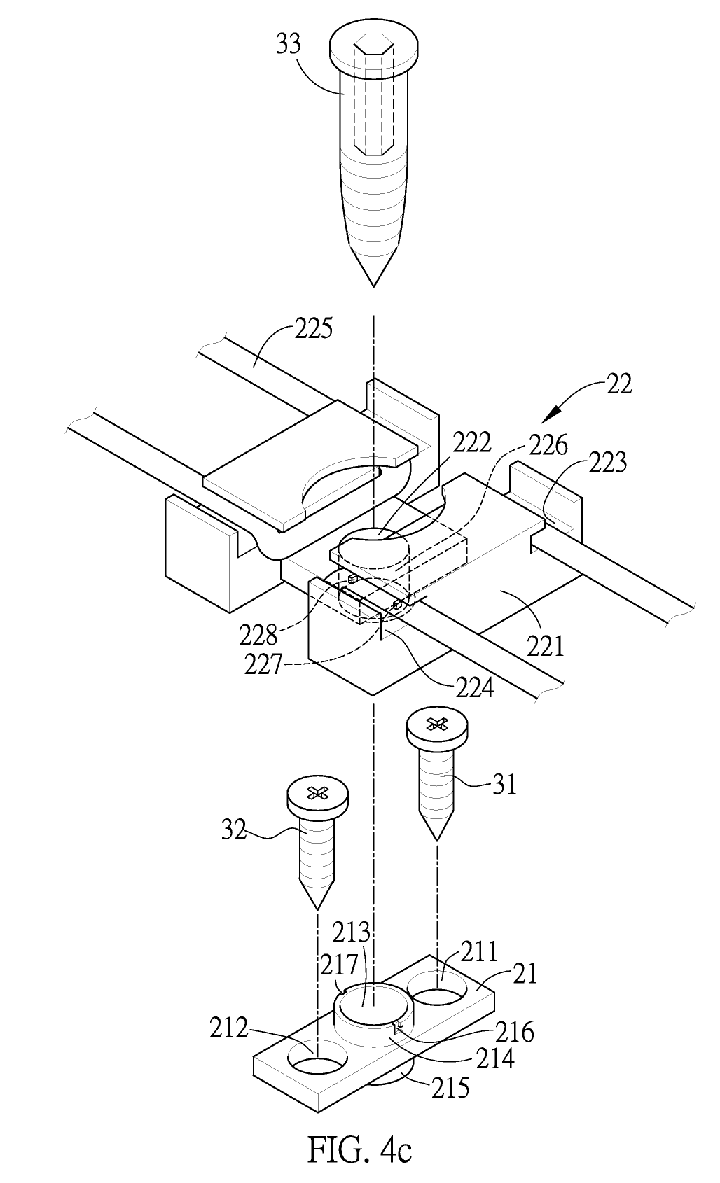

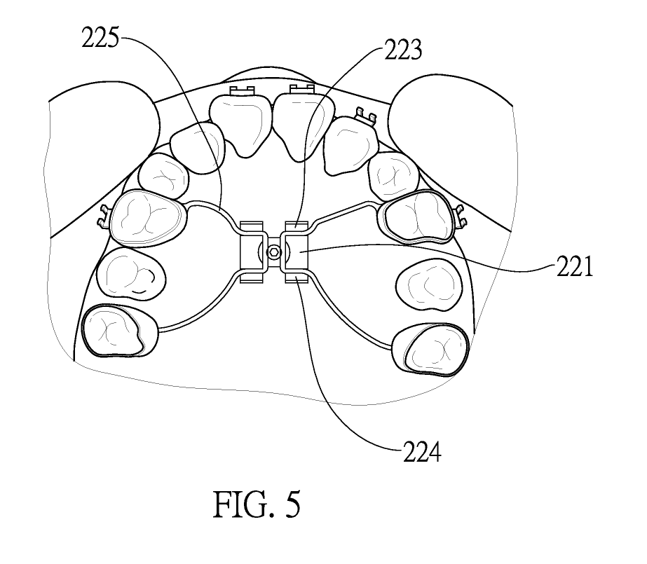

In FIGS. 4a and 4b, the corrective accessory 22 comprises a main body 221, a fourth fixed locking hole 222 situated at a central position on the main body 221, and a first groove 223 and a second groove 224 formed on opposite sides of the main body 221 respectively for accommodating at least one orthodontic wire 225.

If the gap between posterior teeth on both sides of the maxilla of an orthodontic patient is too small for performing an orthodontic correction, then orthodontists have to cut the mucosa tissue of the maxilla with a knife to make an opening (not shown in the figure) and bore a hole (not shown in the figure) at the bottom of the maxillary bone to install plate 21 into the opening, where the second circular protrusion 215 on plate 21 is secured through this hole, thus securing the orthodontic maxillary micro implant.

The first locking element 31 and the second locking element 32 pass through the first locking hole 211 and the second locking hole 212 thus firmly attaching plate 21 to the underside of the maxilla. The previously cut mucosa tissue then covers plate 21. After this mucosa tissue covers the plate 21, the mucosa tissue is trimmed on circular protrusion 214 to be even with the surface of plate 21, thus allowing the hole of the third locking hole 213 to be exposed on the outside.

In the process of inserting the plate 21 into the cut section, the one circular protrusion 214 on the surface of plate 21 can be placed inside the hole for securing its position, then the first locking element 31 and the second locking element 32 are inserted through the first locking hole 211 and the second locking hole 212 respectively to lock the plate 21 to the underside of the maxilla, and the cut mucosa tissue covers plate 21. After the mucosa tissue covers plate 21 and is cut to be even with the second circular protrusion 215 on the other side of the plate 21, the third locking hole is 213 is exposed to the outside.

In this preferred embodiment, the first circular protrusion 214 and the second circular protrusion 215 are hollow and opposite each other.

The corrective accessory 22 (as shown in FIG. 4b) is situated in the center of plate 221, and plate 221 has a socket 226 extending downwards from locking hole 222. The third locking element 33 is inserted and passes through the fourth locking hole 222 in the center of the main body 221, as well as passing through the first circular protrusion 214, the third fixed locking hole 213 and the second circular protrusion 215 to be affixed to the maxilla. Orthodontic wire 225 is attached to corrective accessory 22 and orthodontic wire 225 is coupled to a brace (as shown in FIG. 5) to achieve realignment of the orthodontic patients teeth.

In this preferred embodiment, the orthodontic wire 225 is bent into a U-shape and passes through the first groove 225 and the second groove 224 on the main body 221.

The way of combining the corrective accessory 22 with the plate 21 is not limited to the above described method only, but they can be combined by different methods. For example, in FIG. 4c, a positioning channel 216 is added on the outside of the external periphery of the first circular protrusion 214, and a second positioning channel 217 is added on the other side of the external periphery of the first circular protrusion 214 and positioned opposite to the first positioning channel 216. A positioning flange 227 is situated on the internal side of socket 226, and a second positioning flange 228 is situated on the other side of the socket 226 and is situated directly opposite to the first positioning flange 227. When the corrective accessory 22 and the plate 21 are combined, the first positioning flange 227 situated in the socket 226 will enter into the first positioning channel 216 situated on the external periphery of the first circular protrusion 214 and be inserted and turned to a fixed position, also the second positioning flange 228 situated in socket 226 will enter into the second positioning channel 217 and be turned to a fixed position, thus allowing the corrective accessory 22 and plate 21 to combine more securely, but it is noteworthy to point out that the installation of the positioning channel 216, the second positioning channel 217, positioning flange 227 and the second positioning flange 228 is not limited to the above arrangement, but they can also be arranged in different ways. For example, the first positioning channel 216 and the second positioning channel 217 are formed on the internal side of the socket 226, and the first positioning channel 216 and the second positioning channel 217 are situated directly opposite each other, and the first positioning flange 227 and the second positioning flange 228 are situated on the external periphery of the first circular protrusion 214, and the first positioning flange 227 and the second positioning flange 228 are directly opposite each other.

In this preferred embodiment, the first groove and the second groove on plate 22 are situated opposite each other for accommodating the orthodontic wire 225 therein.

In this preferred embodiment, the main body 221 of the orthodontic appliance 22 is notably H-shaped.

In summation of the description above, the orthodontic maxillary micro implant of the present invention comprising of plate 21 and the orthodontic appliance 22, will not be affected by the growth and angle of placement of the orthodontic patient's teeth. Compared to conventional orthodontic plates for realigning of maxillary teeth that make use of the patient's teeth for support, the present invention will not cause any difficulty in talking, eating, chewing or swallowing for the patient during the teeth realignment (orthodontic) process. In addition, the patient's anterior teeth will not protrude forward after the realignment takes place. Obviously, the present invention can overcome the shortcomings of the prior art.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An orthodontic maxillary micro implant, comprising:
a plate, having a first locking hole and a second locking hole situated at opposite ends of the plate respectively and penetrating through the plate, and a third locking hole situated between the first locking hole and the second locking hole; and
a corrective accessory, having a main body, a fourth locking hole situated at a central position on the main body, and a first groove and a second groove formed on the main body for accommodating at least one orthodontic wire.

2. The orthodontic maxillary micro implant of claim 1, wherein the third locking hole includes a first circular protrusion and a second circular protrusion extending from both surfaces of the plate respectively.

3. The orthodontic maxillary micro implant of claim 1, wherein a fourth locking hole includes a socket extending from the bottom of the fourth locking hole, and at least one positioning flange formed on an internal side of the socket.

4. The orthodontic maxillary micro implant of claim 3, wherein the first or second circular protrusion includes at least one positioning channel situated on the external periphery of the first or second circular protrusion for attaching to the positioning flange.

5. The orthodontic maxillary micro implant of claim 1, wherein the first circular protrusion and the second circular protrusion are hollow and situated opposite each other.

6. The orthodontic maxillary micro implant of claim 1, wherein the first groove and the second groove are situated opposite each other for accommodating the orthodontic wire therein.

7. The orthodontic maxillary micro implant of claim 1, wherein the main body of the correction accessory is notably H-shaped.

8. The orthodontic maxillary micro implant of claim 1, wherein the first locking hole and the second locking hole are situated opposite each other.
